(19) United States
(12) Patent Application Publication
(10) Pub. No.: US 2004/0246945 A1
(43) Pub. Date: Dec. 9, 2004

(54) Method for controlling traffic in a virtual trunking process via a packet-oriented network

(76) Inventors: Andreas Knaebchen, Muenchen (DE); Rainer Liebhart, Schrobenhausen (DE)

Correspondence Address: Siemens Corporation, Intellectual Property Department, 170 Wood Avenue South, Iselin, NJ, 08830, US

(21) Appl. No.: 10/493,076

(22) PCT Filed: Oct. 17, 2002
(86) PCT No.: PCT/DE02/03935

(30) Foreign Application Priority Data
Oct. 18, 2001 (DE) 101 51 442.5

(51) Int. Cl. H04L 12/66

(52) U.S. Cl. 370/352; 370/395.5

(57) ABSTRACT

In a virtual trucking process, call-related quality data is provided via IP-based networks. Said data is used to reduce the traffic in the IP network, based on its origin or route and potentially to divert said traffic, in order to maintain the voice quality of the existing and new calls at a sufficiently high level.

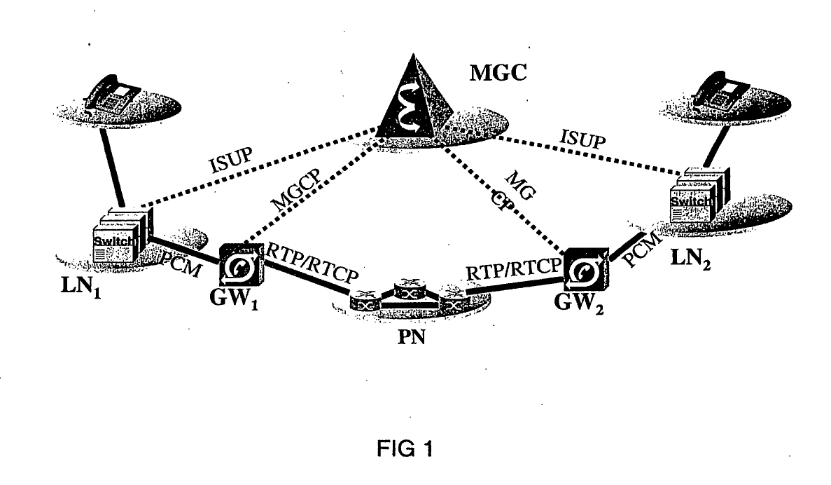

‘Virtual Trunking’ is taken to mean the transmission of telephone or fax connections between two subscribers of the “normal” telephone network (PSTN or ISDN) via a packet network such as an IP network for example. The interworking between the telephone network and the packet network here is handled by gateways which are connected to the telephone network over conventional PCM routes and convert the voice signals into packets. The gateways are controlled via Media Gateway Controllers (MGC) which process and forward the signaling messages coming from the telephone network (e.g. ISUP messages). In this case a number of MGCs can be involved in a connection. Each connection is thus controlled in the MGC, the gateways basically obtain setting commands from the MGC to seize or release a specific PCM port. MGCP or MEGACO (Media Gateway Control Protocol) can be used as a control protocol for example. An overview of the virtual trunking scenario can be found in FIG. 1.

‘Quality of Service’ (QoS) is defined differently depending on the context and as a result is evaluated with different netrics in each case. Known examples of metrics for measuring quality of service are the maximum amount of information that can be transferred (bandwidth), the amount of information transferred, the amount of information not transferred (loss rate), the—if nec. averaged—time delay for transmission ((transmission) delay), the—if nec. averaged—deviation from the otherwise normal gap between two information transmissions (delay jitter, interarrival jitter), or the amount of information not allowed to be transmitted at all (blocking rate).

Whereas good voice quality is ensured in the digital telephone network by using fixed channels with a capacity of 64 kbps, a packet network per se does not offer sufficient quality for voice transmission, except where the network is overdimensioned in such a way as to be able to accept any traffic which might possibly arise. In the case of virtual trunking the voice quality is however of particular importance since the subscriber should not be able to notice any difference in quality compared to a circuit-switched network. No direct added value also exists for the subscriber compared to circuit switched telephony.

Currently a number of methods are being investigated for safeguarding transmission quality in packet networks in the various standardization bodies, for example at the IETF. As just one example the division of the packets into various prioritization classes should be mentioned (DiffServ approach), where speech is given very high priority. However there are as yet no full-coverage implementations of these methods. In addition, despite the use of these methods, bottlenecks in the packet network triggered by overload or hardware failures can arise which then adversely affect the voice quality of many connections.

It would be desirable and important for the acceptance of virtual trunking to react to overload or hardware failures in such a way that at least the voice quality subjectively perceived by the customer does suffer any lasting effects.

Manual interventions in the MGC or in an upstream PSTN/ISDN exchange to thin out the traffic from a specific origin or to a specific destination are known when reductions in transmission quality occur in packet switched networks. The operators of the packet network collect data about the quality of the connections (if possible) for this purpose and make it available to the operators of the MGC or the exchanges in the telephone network. These then initiate (with the corresponding delay) measures to restrict the traffic. If the voice quality improves again the restriction mechanisms are cancelled again manually. This method is susceptible to errors and liable to major delays. If no QoS data can be determined by the operator of the packet network suitable measures can only be taken as a result of test connections or customer complaints.

The object of the invention is to improve the prior art described here.

This object is achieved by the invention described in the claims.

It is proposed that the current status of the transmission quality in the packet network for connections between two gateways be determined, and if the quality is bad, access to the network via specific gateways be restricted and possibly traffic diverted to other gateways to enable the load to be relieved on overloads or defective accesses or paths. The result of this is that the voice quality perceived objectively and subjectively by the customer does not suffer any lasting adverse effects.

One aspect of the invention lies in providing connection-related quality data in the case of virtual trunking over IP-based networks and by means of this data, of reducing the traffic in the IP network on an origin- or path-related basis, and possibly diverting it in order it to retain a sufficiently high voice QoS level for existing and new connections.

The present invention starts from the fact that for the transmission of payload data such as voice over an IP network, the RTP*(Real Time Protocol) is used. RTP and its associated control protocol RTCP

(Real Time Control Protocol) offer the opportunity on both sides of the connection, that is with virtual trunking in the two gateways involved, of collecting and evaluating data about the QoS of the connection in the forwards and backwards direction. This data contains values for example about the average delay time of the packets sent and received or about the number of packets lost.

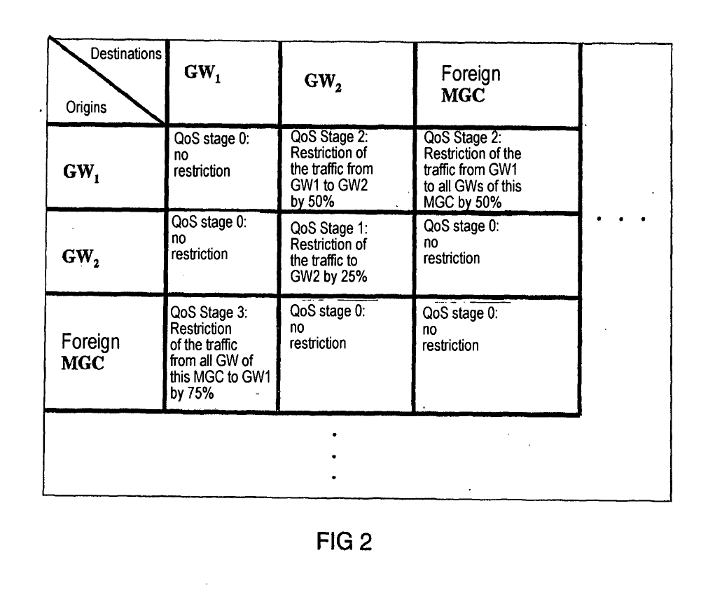

It is proposed that the gateways collect the QoS data for a connection and send it at the end of the connection to the MGC. In the MGC a matrix is now constructed from all possible origins and destinations, that is all gateways controlled by the MGC and other MGCs with which signaling messages are exchanged. FIG. 2 shows an example of such a matrix. In this matrix the QoS data supplied by the individual gateways is stored transiently and evaluated (alternatively the gateways can also already have evaluated the data and sent it to the MGC). Data from gateways which are controlled by a foreign MGC is summarized under the entry for the foreign MGC. Depending on the length of the delays, the number of packets lost or other QoS data, different stages of QoS restriction can be defined for each origin/destination relationship. Depending on the QoS stages determined, measures can now be defined for each individual element of the matrix (this corresponds precisely to the path from one origin to one destination gateway) or for the matrix as a whole. These measures define how much of the traffic from the origin gateway to the destination gateway is to be rejected for a specific QoS stage. The measures which relate to a gateway independently of a specific destination are entered in this case on the diagonals of the matrix. If there are HW failures in the gateway itself or in the access area of the gateway this allows general restrictions to be imposed on the traffic to this gateway. The QoS stages determined can also be used to generate alarms or tickets which explicitly inform the network operator about QoS problems.

Typical restriction measures which can be used are the percentage thinning out of the traffic, blocking traffic at particular times or reduction of the traffic to a defined call rate (leaky bucket). When restriction of the traffic has taken place it is possible in upstream exchanges to conduct a new path search and thus direct the rejected traffic via another gateway into the IP network.

If the ongoing collected and evaluated QoS data indicates that the QoS has improved, any restriction measures which may have been initiated are automatically cancelled again.

The solution described links the known restriction mechanisms from circuit-switched networks such as percentage restriction of traffic to a destination to the specific term QoS only known for packet networks. The evaluation of the available QoS data and the resulting stages of loss of QoS for an origin/destination relationship is used as a trigger for automatic activation of reduction measures.

Advantages that can be mentioned for the approach described are the automatic connection-linked collection and evaluation of QoS data and the automatic restriction of the traffic involved. This allows a very rapid reaction to a degradation of the QoS on specific paths through the IP network or also in the direct environment of a gateway and a reaction which is independent of the destination. The automatic restriction of the traffic reduces the load on the routes of the traffic network involved and thus contributes to the stability of the network or of individual parts of the network.

Since RTP/RTCP have been standardized as the transmission protocols for the media stream (e.g. voice) in the IP area by the IETF, it is both technically and also economically especially advantageous to collect and to transmit QoS data in a standard way.

The automatic detection of QoS problems and the initiation of suitable countermeasures enjoys high priority for all providers of virtual trunking scenarios because of the resonance with the customer.

The invention is explained below in more detail on the basis of exemplary embodiments which are shown in the figures. The drawing shows:

FIG. 1 an arrangement to execute the method in accordance with the invention which is embodied as a hybrid network with a packet-oriented IP network (PN) in the core and circuit-switched telephone networks (LN) in the access area,

FIG. 2 Example of a QoS matrix of a Gateway Controller (MGC) for virtual trunking containing QoS-specific connection data and data for reducing the traffic between gateways (GW) in the virtual trunking scenario.

A Gateway GW sends QoS data at the end of each connection, such as

number of packets sent and received,

Number of packets lost,

Average jitter value,

Average packet delay

to the associated Media Gateway Controller MGC by means of MGCP or MEGACO. The options provided both by MGCP and also by MEGACO are used advantageously here to transfer quality-related connection data from the Gateway GW to the associated MGC. The MGC knows the origin and destination of the connection and sets the QoS data contained in relation to previously contained QoS data which is also assigned to this origin/destination relationship. Starting from a defined minimum number of connections, statistical statements about the quality of the path from the origin to the destination can be made from this. If the QoS values determined exceed specific limit values countermeasures can be initiated automatically which restrict the traffic between the origin and destination observed. If the QoS values determined in the future indicate an improvement in the situation in the IP network the traffic restriction is automatically downgraded or deactivated completely.

Advantageously each implementation gives the operator of the MGC the option of selecting the type of countermeasure.

Finally it should be stressed that the description is not to be seen as basically restricting the components relevant for the invention.

For a relevant expert it is especially evident that terms such as ‘Gateway’ or ‘Gateway Controller’ are to be understood functionally and not physically. Thus they can also be realized for example partly or completely in software and/or distributed over a number of physical devices.

1-19. (canceled)

20. A method for controlling traffic in a virtual trunking process via a packet-oriented network, comprising:
automatically determining quality data which is representative of the current transmission quality in the packet-oriented network;
automatically evaluating the quality data using at least one prespecified criterion as the yardstick;
if the criterion is not fulfilled:
automatically controlling the transmission of traffic in relation to the packet-oriented network in such a way that the transmission quality of the traffic streams existing in this network and of new traffic streams remains at a sufficiently high QoS level.

21. A method in accordance with claim 20, wherein traffic control comprises an origin and/or path-related reduction of the traffic streams.

22. A method in accordance with claim 20, wherein the sufficiently high level is reached when the transmission quality perceived objectively and/or subjectively by the customer does not suffer.

23. A method in accordance with claim 20, wherein the quality data is determined individually for each traffic stream transmitted.

24. A method in accordance with claim 20, wherein the quality data is determined with the aid of the RTP protocol.

25. A method in accordance with claim 20, wherein the quality data is collected during the transmission of a traffic stream and evaluated after its transmission.

26. A method in accordance with claim 20, wherein the quality data is collected in gateways of the packet-oriented network.

27. A method in accordance with claim 26, wherein the quality data is analyzed in the gateways and/or after its transmission in at least one Gateway Controller assigned to the gateways.

28. A method in accordance with claim 27, wherein the traffic control is effected by taking account of a matrix in which at least one value is stored for each relationship between all origins and destinations of the network, which at least communicably representative of the transmission quality between the relevant origin and the relevant destination.

29. A method in accordance with claim 28, wherein at least one value is stored on the diagonals of the matrix which is at least communicably representative of the transmission quality of the relevant origin or the relevant destination.

30. A method in accordance with claim 28, wherein, when the matrix is assigned to the Gateway Controller, the origins and destinations correspond to the gateways which are controlled by the Gateway Controller as well as to all further Gateway Controllers with which signaling messages are exchanged.

31. A method in accordance with claim 28, wherein at least one communicable measure for traffic control is derived from the value.

32. A method in accordance with claim 31, wherein the measure defines how much of the traffic from the given origin to the given destination will be rejected.

33. A method in accordance with claim 20, wherein the traffic is subject to more sustained control the worse the transmission quality becomes.

34. A method in accordance with claim 20, wherein in the case of an improvement of the previously reduced transmission quality an existing or initiated traffic control is automatically cancelled.

35. A method in accordance with claim 20, wherein in the case of traffic control in an upstream exchange (LN) a new path search is conducted to determine alternate paths.

36. A method in accordance with claim 20, wherein the network is an IP network.

37. A method in accordance with claim 21, wherein the reduction of the traffic streams is effected by a defined call rate, a rerouting, a thinning out and/or time restriction of the traffic streams.

38. A computer program product comprising software code sections to perform a method for controlling traffic in a virtual trunking process via a packet-oriented network, the method comprising:
automatically determining quality data which is representative of the current transmission quality in the packet-oriented network;
automatically evaluating the quality data using at least one prespecified criterion as the yardstick;
if the criterion is not fulfilled:
automatically controlling the transmission of traffic in relation to the packet-oriented network in such a way that the transmission quality of the traffic streams existing in this network and of new traffic streams remains at a sufficiently high QoS level.

39. A computer program product in accordance with claim 38, wherein the computer program product is used in a packet-oriented network.

40. A device comprising at least one mechanism for performing a method for controlling traffic in a virtual trunking process via a packet-oriented network, the method comprising:
automatically determining quality data which is representative of the current transmission quality in the packet-oriented network;
automatically evaluating the quality data using at least one prespecified criterion as the yardstick;
if the criterion is not fulfilled:
automatically controlling the transmission of traffic in relation to the packet-oriented network in such a way that the transmission quality of the traffic streams existing in this network and of new traffic streams remains at a sufficiently high QoS level.

41. A device in accordance with claim 40, wherein the device is a Gateway or a Gateway Controller.

42. A device in accordance with claim 40, wherein the device is part of a packet-oriented network.
